(19) United States
(12) Patent Application Publication
(10) Pub. No.: US 2004/0201180 A1
(43) Pub. Date: Oct. 14, 2004

(54) Exhaust pipe flange ring gasket

(76) Inventors: Kanu G. Shah, Arlington Heights, IL (US); Thomas E. Staab, Chicago, IL (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/126,713

(22) Filed: Apr. 19, 2002

(51) Int. Cl. F16J 15/46

(52) U.S. Cl. 277/592; 277/628; 277/602

(57) ABSTRACT

An improved exhaust pipe flange ring gasket is principally defined by a pair of mating exhaust pipe flanges. One of the flanges has an annular groove extending in the one of the mating flanges. One or more metal Belleville spring washers or wave spring washers are wrapped within a stainless cover to define a hoop-style spring ring disposed within the groove. The metal washer replaces a traditional spiral wound core or graphite filler that tends to oxidize at high operating temperatures; such oxidation adversely affects sealing performance. Conversely, the washer, which can be either a Belleville or wave spring, is comprised of a hard stainless steel that will not oxidize at high operating temperatures. Gasket sealing performance is vastly improved, even though the Belleville or wave spring washer is relatively inexpensive. The Belleville or wave spring washer provides relatively stiff spring resilience to accommodate deflection along its axial compressive direction.

### BACKGROUND OF THE INVENTION

1. Field of Invention

This invention relates to gaskets employed in vehicles, and particularly to metallic gaskets employed in exhaust pipe systems of vehicles.

2. Description of the Prior Art

Exhaust systems used in automotive vehicles are subject to great variations in temperature, as well as to extreme mechanical vibrations. As such, the gaskets associated with vehicle exhaust systems are known to present difficult sealing challenges. For example, the gaskets interposed between exhaust connection parts of vehicles are required to maintain resilient sealing properties over extended periods of time.

The choices of gasket materials used under such severe conditions have included metal-covered gaskets with soft core members, such as heat resistant fibers. More recently, the use of expanded graphite and/or mica covered by a metallic sheet has been popular. Such metal-covered gaskets have provided relatively soft-core members that offer excellent heat resistance, while the metallic coverings offer rigidity, as well as some protection of the core members from deleterious environmental exposure. However, such gaskets have been subject to reduction of contact pressure between connected parts over a period of time, along with deterioration of sealing properties under conditions of cyclic thermal expansion and vibrations, and thus spring recovery properties of such composite material bodies have not held up over time. In addition, graphite fillers used in such gaskets have been subject to severe oxidation, which compromises integrity of the gasket structures.

Spiral-wound gaskets have been offered to overcome issues of resiliency, hence recovery, as well as oxidation. However, most spiral-wound gaskets have been formed of complex structures that are expensive to manufacture and are subject to oxidation. As a result, such gaskets have not been feasible for many applications.

### SUMMARY OF THE INVENTION

The present invention provides an improved gasket assembly that is simpler in construction than the soft-core style gaskets, and is more reliable than the spiral-wound gaskets of the prior art. The described invention is defined by a generally annular, exhaust ring gasket body comprised of a stainless steel protective cover that fully encases an internal spring mechanism. One or more metal Belleville spring washers or wave spring washers are wrapped in a protective stainless cover to define a hoop-style spring ring. The spring ring is in turn disposed within a groove extending about an exhaust aperture on one of two mating exhaust pipe flanges.

The washer replaces a spiral wound core or traditional graphite filler that oxidizes at high operating temperatures and adversely affects sealing performance. The washer, whether Belleville or wave spring, is comprised of a hard stainless steel that will not oxidize at high operating temperatures. The spring washer can be stacked with other washers, or run opposed to one another to create a more robust spring ring system for harsher applications. In some instances, size and space requirements may dictate that only one spring can be used. The dimensions of the gasket will obviously vary with each application.

In one described embodiment, the Bellville is formed of a stainless steel spring material. An outer circumferential metal wrap that is softer than the resilient spring metal of the Bellville covers the Bellville; the wrap thus conforms more readily to the resilient characteristics of the Bellville. In its described form, the outer wrap also comprises a metal of stainless steel that entirely covers the exterior surfaces of the Bellville to avoid oxidation.

### BRIEF DESCRIPTION OF THE DRAWINGS

FIG. 1 is a perspective view of an exhaust pipe flange constructed to accept the described embodiments of the present invention.

FIG. 2 is a plan view of a hoop-style spring ring gasket element constructed in accordance with one described embodiment of the present invention.

FIG. 3 is a cross-sectional view of the hoop-style spring ring gasket element, taken along lines 3-3 of FIG. 2.

FIG. 4 is a cross-sectional view of the exhaust pipe flange of FIG. 1, taken along lines 4-4 of FIG. 1, depicting the hoop-style spring ring element of the exhaust ring gasket, shown installed within a groove of one of the pipe flanges and assembled against a mating non-grooved pipe flange.

FIG. 5, a cross-sectional view of an alternate hoop-style spring ring element that is analogous to the spring ring element of FIG. 3, is a view taken along lines 3-3 of FIG. 2.

FIG. 6, a cross-sectional view of an alternate hoop-style spring ring element analogous to the spring ring element of FIG. 3, is a view taken along lines 6-6 of FIG. 2.

### DETAILED DESCRIPTION OF EMBODIMENTS

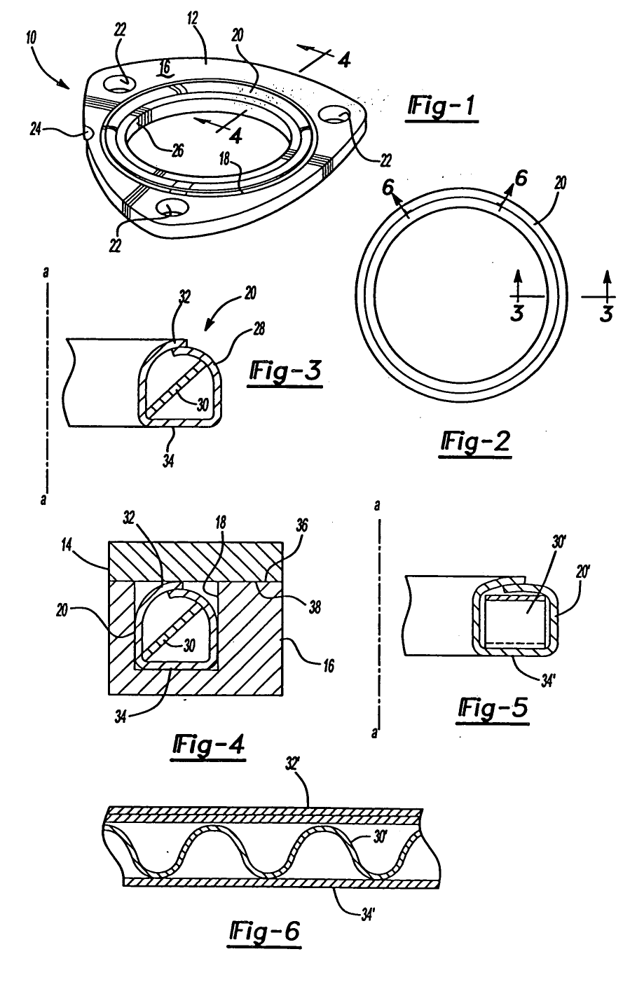

Referring initially to FIGS. 1-4, an exhaust pipe flange assembly 10 has two mating generally annular flanges 12. The flanges 12 consist of an upper non-grooved layer 14 and a mutually facing grooved lower layer 16, as detailed in FIG. 4. In FIG. 1, only the bottom layer is shown for purposes of revealing an annular primary sealing groove 18. The groove 18 is situated in the lower layer 16 for the purpose of accommodating a hoop-style spring ring gasket element 20. Continuing reference to FIG. 1, the exhaust pipe flange assembly 10 has a plurality of bolt holes 22 adapted for securement of the gasket element 20 between the described pair of flanges. The pipe flange assembly 10 also may incorporate an orientation notch 24 for assuring proper orientation upon assembly, as will be appreciated by those skilled in the art. Finally, a gas passage aperture 26 defines the internal diameters of the pipe flanges 14 and 16, about which the primary sealing groove 18 is circumferentially disposed on Flange 16.

Referring now more particularly to FIGS. 2 and 3, the hoop style spring ring gasket element 20 may be described in greater detail. The exterior or outer portion 28 of the gasket element 20 is defined by a stainless-steel hoop wrap (28) having a flattened bottom portion 34 in the described embodiment for accommodating the spring washer 30. The hoop wrap 28 is overlapped at its top portion 32, as shown. Situated internally of the hoop wrap 28, the Belleville spring washer 30 flattens under compressive forces when compressed along an axis “a-a” (FIG. 3), as for example during cyclic heating and cooling of the exhaust pipe flange assembly 10. The Bellville spring 30 is formed of stainless steel 301 or similar material, and is thus relatively hard and durable. The hoop wrap 28 in the described embodiment is 304 or 321 stainless steel to provide a relatively soft outer cover or wrap.

In FIG. 4, the assembled ring gasket element 20 is shown installed in the groove 18. The element 20 is fully covered by the upper layer 14 (not shown in FIG. 1, though taken at the cross-section shown), for completion of the assembly of the exhaust pipe flanges 10. It is contemplated that the radially extending edges (not shown) of the layer 14 are symmetrically coterminous with corresponding edges (also not shown) of the lower layer 16, as will be fully appreciated by those skilled in the art.

Turning now to FIGS. 5 and 6, an alternate embodiment of a hoop style spring ring gasket element 20′ is defined by a ribbon-like, sinusoidal spring steel mechanism as provided via a wave style spring ring 30′. Those skilled in the art will appreciate that the Belleville washer 30 or the wave style spring ring 30′ will provide a mechanism, which when wrapped in the stainless-steel outer portion 28, is effective to resiliently seal an exhaust pipe flange assembly 10 over a much longer life of thermal cycles than will be provided via the use of a graphite composite material. In some cases, the cylic fluctuations will extend from well below freezing conditions up to a temperature range of 1200° F. to 1500° F. In addition, the described structure will be considerably more reliable than the use of a spiral wound gasket or graphite composite material.

Those skilled in the art will appreciate that appropriate dimensional tolerancing will be necessarily variable from application to application. However, one dimension for the gasket for automotive passenger car use, as an example, includes an axial cross-sectional dimension of 4.0 mm. The depth of the groove 18 is approximately 3.0 mm, providing a compressibility dimension of 1.0 mm. In yet another automotive exhaust application, the axial dimension of the gasket is 4.3 mm with a 3.3 mm groove depth. It will be noted that the faces 36, 38 (FIG. 4) of the upper and lower layers 14, 16, respectively, that mate together to form the exhaust pipe flange assembly 10 are flat faced. Thus, at least with respect to the dimensions set forth in the example, there is no need to have a groove or recess in both layers 14, 16.

It is to be understood that the above description is intended to be illustrative, and not limiting. Many embodiments will be apparent to those of skill in the art upon reading the above description. The scope of the invention should be determined, however, not with reference to the above description, but with reference to the appended claims and the full scope of equivalents to which the claims are entitled by law.

1. A generally annular gasket for sealing between a pair of mutually facing, axially spaced-apart interface surfaces, said gasket comprising a hoop wrap that includes a bottom portion and side portions that overlap so as to form a continuous metallic outer portion defined by a periphery, said periphery of said metallic outer portion completely enclosing at least one metal spring washer.

2. The gasket of claim 1, wherein said spring washer comprises a stainless steel Bellville-style washer.

3. The gasket of claim 1, wherein said outer portion comprises stainless steel material for oxidation resistance.

4. The gasket of claim 1, wherein both said washer and said outer portion comprise stainless steel materials.

5. The gasket of claim 4, wherein said washer comprises an SAE 301 stainless steel material for hardness and spring characteristics.

6. The gasket of claim 4, wherein said outer portion comprises an SAE 304 stainless steel to provide a relatively soft outer surface of said gasket.

7. The gasket of claim 1, wherein the combination of said outer portion and said washer comprises a gasket, which retains resiliency under cyclic thermal cycles from below freezing to a temperature range of 1200° F. to 1500° F.
